(19) United States
(12) Patent Application Publication
(10) Pub. No.: US 2014/0268698 A1
(43) Pub. Date: Sep. 18, 2014

(54) Self cooling, magnetically connected fixtures for large area directional and isotropic solid state lighting panels

(71) Applicants: Scott M. Zimmerman, Basking Ridge, NJ (US); William R. Livesay, San Diego, CA (US); Richard L. Ross, Del Mar, CA (US); Eduardo DeAnda, San Diego, CA (US)

(72) Inventors: Scott M. Zimmerman, Basking Ridge, NJ (US); William R. Livesay, San Diego, CA (US); Richard L. Ross, Del Mar, CA (US); Eduardo DeAnda, San Diego, CA (US)

(21) Appl. No.: 13/815,680

(22) Filed: Mar. 14, 2013

(51) Int. Cl. F21V 13/08; F21L 4/08; F21V 29/00

(52) U.S. Cl. CPC F21V 13/08; F21V 29/004; F21L 4/08
USPC 362/183; 362/296.01; 362/294; 362/398; 362/249.01; 362/297

(57) ABSTRACT

Reflector designs for a large area panel light source create induced draft cooling means adjacent to the panel light source. The panel light source has a wavelength conversion element on a solid-state light source for emitting light of a first and second wavelength to form a broader emission spectrum of light from the panel light source. Magnetic elements make electrical connection between the fixture contacts and the light source contacts on the panel light source for a light fixture.

### REFERENCE TO PRIOR APPLICATION

This application is a continuation-in-part patent application, which claims the benefit of U.S. patent application Ser. No. 12/380,439, which was filed on Feb. 27, 2009, which is herein incorporated by reference, which claimed the benefit of U.S. Provisional Patent Application Ser. No. 61/067,934, which was filed on Mar. 1, 2008, which is herein incorporated by reference.

### BACKGROUND OF THE INVENTION

Panel light fixtures are typically designed to take into account the light distribution, intensity, and thermal characteristics of the source. Panel light fixtures have historically been incandescent light bulbs or fluorescent light bulbs. A wide range of reflectors and optical devices have been developed over the years to generate a particular output distribution and/or deliver maximum efficiency for an incandescent light bulb.

Fluorescent light bulbs work differently than incandescent light bulbs. An incandescent light has electricity pass through a filament, which emits light. A fluorescent light is a gas discharge light where electricity excites mercury vapor, which emits ultraviolet light. The ultraviolet light strikes phosphors in the fluorescent light, which in turn emit visible light. Fluorescent light bulbs have the added need of ballasts or other electronic methods of converting the available power into a useful form. Fluorescent light bulbs use different reflectors and different optical devices from an incandescent light bulb to achieve a similar result of a particular output distribution and/or maximum efficiency for a fluorescent bulb.

A new light source based on a distributed array of light emitting diodes (LEDs) within a solid luminescent element has been disclosed by Zimmerman et al. in U.S. Pat. No. 7,285,791, commonly assigned as the present application and herein incorporated by reference. Electricity passes through an active region of semiconductor material to emit light in a light emitting diode. The solid luminescent element is a wavelength conversion chip. US Published Patent Applications 20080042153 and 20080149166, commonly assigned as the present application and herein incorporated by reference, teach wavelength conversion chips for use with light emitting diodes. A light emitting diode, such as those in US Published Patent Applications 20080182353 and 20080258165, commonly assigned as the present application and herein incorporated by reference, will emit light of a first wavelength and that first wavelength light will be converted into light of a second wavelength by the wavelength conversion chip.

A panel light source can be made in a variety of shapes and output distributions ranging from directional to isotropic using thermally conductive luminescent elements. Power conditioning and control electronics can also be incorporated into the bulb itself since the thermally conductive luminescent element is a solid. A variety of means can connect to the available power source. In addition, the distributed nature of the sources allows for cooling via natural convection means as long as sufficient airflow is allowed by the light fixture eliminating or greatly reducing the need for additional heat sinking means. It also provides a substrate for integration of solar and energy storage means.

In most cases, existing LED light sources are based on high intensity point sources, which required extensive thermal heat sinking to operate and distribute the heat generated in the point sources over a large area. The localized nature of these high intensity point sources dictate that large heat sinks must be used especially in the case of natural convection cooled applications. While 100 lumen/watt performance levels have been demonstrated for bulbs outside the fixture, performance can degrade as much as 50% once this type of solid state light source is used inside the fixture due to airflow restriction and lack of ventilation. This is especially true for the cases where fixtures are surrounded by insulation, as is the case for most residential applications. The heat sinks typically required to cool these high intensity point sources are both heavy and present a hazard especially in overhead lighting applications, where a falling light fixture could severely injure someone.

Additionally, the fact that the source is so localized means that some type of distribution or diffusing means must be used to deal with the brightness level generated. This is required from an aesthetic and safety point of view. The small nature of the source means that imaging of the source on the retina of the eye is of great concern. This is especially true for UV and blue sources due to additive photochemical effects. In general, brightness levels greater than 5,000 to 10,000 FtL are uncomfortable for direct viewing especially at night. High intensity point sources can be several orders of magnitude higher brightness than what can be comfortably viewed directly. The resulting glare has to be addressed by additional optical elements, which add cost and weight.

Lastly, the localized nature of the heat source generated by these high intensity point sources dictate that high efficiency heat sink designs must be used which are more susceptible to dust and other environmental effects especially in outside applications. This dictates periodic maintenance of the light sources, which is impractical in many cases. The need therefore exists for improved fixtures that can provide directional control, allow cooling of the sources, and safely illuminate homes and businesses.

Standardization is also a problem with solid-state lighting. LED manufacturers provide standard packages for their LEDs but LED packages are not the same between manufacturers. Further, the user and fixture suppliers are left to integrate heat sinks into their application or design, which then are custom as well. This leads to each solid-state light source being a unique and non-interchangeable element. The need exists for a solid-state light source solution which includes the optical source, cooling means, and electrical interconnect means which can then be standardized. Incandescent and fluorescent lamps provide all three of these functions because they are self cooling. The need therefore exists for a self-cooling solid-state light source, which includes optical, cooling and electrical interconnect means into one element.

### SUMMARY OF THE INVENTION

According to the present invention, a solid state light source, such as a light emitting diode, an organic light emitting diode, an inorganic light emitting diode, an edge emitter light emitting diode, a vertical cavity surface emitting laser, or a laser diode, and a thermally conductive luminescent element, such as a wavelength conversion element or a phosphor element, along with a reflector means will form a panel light fixture. The solid-state light source is typically a point light source of a single wavelength but the panel light fixture will transmit light of a broader emission spectrum over a large area.

This disclosure covers a variety of reflector designs for panel light sources and configuration of panel lights containing thermally conductive luminescent elements. The panel light sources disclosed in this invention consist of at least one thermally conductive luminescent element to which at least one solid-state light source is attached, and an interconnect means. The at least one thermally conductive luminescent element converts at least a portion of the light emitted from the at least one solid-state light source into a broader emission spectrum. The at least one thermally conductive luminescent element also serves to diffuse/distribute the light generated. The at least one thermally conductive luminescent element provides a cooling path for itself and the at least one solid-state light source to the surrounding ambient via convection off the surface of the at least one thermally conductive luminescent element. This self-cooling mechanism enables a solid-state light source to cool itself without requiring an appended external heat sink. This eliminates a bulky and expensive component of solid-state sources. This self-cooling mechanism preferably dissipates more than 50% of the waste heat of the solid-state light source. More preferably, the at least one thermally conductive luminescent element enables the formation of panel lights which can be directly viewed with human eye without the need for further diffusion or protective means. In this manner, a self-cooling solid-state light source can be realized.

Although the invention can be practiced with conventional LEDs (having a secondary substrate, the use of freestanding epitaxial LED chips as the solid state light sources is preferred for both directional and isotropic panel lights. The panel lights can be combined with solar conversion and/or energy storage means. In this manner, compact light sources can be created which do not require external power sources.

The use of at least one of these panel light sources in a fixture is a preferred embodiment of this invention. Both directional (Lambertian and narrower angular distribution) and isotropic sources are disclosed in a variety of fixtures. Fixture design can create induced draft cooling channels around or in proximity to the panel light.

As a further embodiment of the invention, magnetic elements can simultaneously make the physical connection and the electrical connection between fixture contacts and the light source contacts on the panel light source. The light fixture only has to contain the contacts and sufficient mechanical integrity to support the panel light source and any associated optical elements like reflectors, diffusers, filters, or lens.

This invention discloses light fixtures that are uniquely enabled by the self-cooling, light in weight, thermally conductive luminescent waveguiding elements. As these light sources are totally self-contained they enable unique fixtures, which are not attainable with conventional solid-state light sources. As an illustration, visualize trying to substitute a conventional LED light source with a bulky and heavy appended heat sink into the fixtures described in this invention. The invention provides simple, aesthetically pleasing and functional light sources unattainable by the prior art.

Other aspects of the invention will become apparent from the following more detailed description, taken in conjunction with the accompanying drawings.

### BRIEF DESCRIPTION OF THE DRAWINGS

FIG. 1 is a side view of a Lambertian directional panel light source of the present invention.

FIG. 2 is a side view of an isotropic panel light source of the present invention.

FIG. 3 is a side view of a wall washer based on a Lambertian panel light with induced draft natural flow cooling of the present invention.

FIG. 4 is a side view of a trough light with an isotropic linear panel light source and flow through cooling of the present invention.

FIG. 5 is a side view of a light panel for improved reflector design of the present invention.

FIG. 6 is a side view of a magnetic connector for Lambertian panels for ceiling lighting of the present invention.

FIG. 7 is side view of a panel light with integrated energy storage means and solar cell.

FIG. 8A is a top view of a self-cooling solid-state light source with magnetic contacts polarity keyed. FIG. 8B is a side view of a self-cooling solid-state light source with magnetic contacts polarity keyed of FIG. 8A.

FIG. 9 is a side view of a coaxial contact for a self-cooling solid-state light source.

FIG. 10 is a side view of a string of magnetically connected self-cooling solid-state light sources.

FIG. 11 is a side view of a light fixture containing at least one magnetically coupled self-cooling light source.

FIG. 12 is side view of a chandelier based on bendable coaxial interconnected self-cooling light sources.

FIG. 13A is a side view of a magnetically mounted self-cooling solid-state light source with pivot pin. FIG. 13B is a top view of a magnetically mounted self-cooling solid-state light source with pivot pin of FIG. 13A.

FIG. 14 is a side view of a self-cooling solid-state light source with integral spade pins.

FIG. 15 is a perspective view of a prismatic self cooling light stick with magnetic contacts

### DETAILED DESCRIPTION OF DRAWINGS

FIG. 1 depicts a Lambertian directional panel light source, which consists of a solid wavelength conversion element 1 with a solid-state light source 6. The light source 6 may be light emitting diode with an active region of a pn junction, single quantum well, multiple quantum wells, single heterojunction or double heterojunction, an organic light emitting diode, an inorganic light emitting diode, an edge emitter light emitting diode, a vertical cavity surface emitting laser, or a laser diode. Electrical interconnect means 2 and 4, including but not limited to, wires, transparent conductive oxides (evaporative and spin-on), thick film conductive pastes, patterned evaporative metals, and conductive epoxies, are positioned on either side of the solid state light source 6 to drive the solid state light source 6 to emit light. The wavelength conversion element 1 is on one surface of the solid-state light source 6. A substantially reflective layer 5 covers the opposite surface of the solid-state light source 6 from the wavelength conversion element 1. The light source 6 is shown as multiple elements and the total emitting area of these elements is much less than the cross-sectional area of the wavelength conversion element 1 to which the light source elements 6 are mounted.

The wavelength conversion element is formed from wavelength conversion materials. The wavelength conversion materials absorb light in a first wavelength range and emit light in a second wavelength range, where the light of a second wavelength range has longer wavelengths than the light of a first wavelength range. The wavelength conversion materials may be, for example, phosphor materials or quantum dot materials. The wavelength conversion element may be formed from two or more different wavelength conversion materials. The wavelength conversion element may also include optically inert host materials for the wavelength conversion materials of phosphors or quantum dots. Any optically inert host material must be transparent to ultraviolet and visible light.

Phosphor materials are typically optical inorganic materials doped with ions of lanthanide (rare earth) elements or, alternatively, ions such as chromium, titanium, vanadium, cobalt or neodymium. The lanthanide elements are lanthanum, cerium, praseodymium, neodymium, promethium, samarium, europium, gadolinium, terbium, dysprosium, holmium, erbium, thulium, ytterbium and lutetium. Optical inorganic materials include, but are not limited to, sapphire (Al.sub.2O.sub.3), gallium arsenide (GaAs), beryllium aluminum oxide (BeAl.sub.2O.sub.4), magnesium fluoride (MgF.sub.2), indium phosphide (InP), gallium phosphide (GaP), yttrium aluminum garnet (YAG or Y.sub.3Al.sub.5O.sub.12), terbium-containing garnet, yttrium-aluminum-lanthanide oxide compounds, yttrium-aluminum-lanthanide-gallium oxide compounds, yttrium oxide (Y.sub.2O.sub.3), calcium or strontium or barium halophosphates (Ca,Sr,Ba).sub.5(PO.sub.4).sub.3(Cl,F), the compound CeMgAl.sub.11O.sub.19, lanthanum phosphate (LaPO.sub.4), lanthanide pentaborate materials ((lanthanide)(Mg,Zn)B.sub.5O.sub.10), the compound BaMgAl.sub.10O.sub.17, the compound SrGa.sub.2S.sub.4, the compounds (Sr,Mg,Ca,Ba)(Ga,Al,In).sub.2S.sub.4, the compound SrS, the compound ZnS and nitridosilicate. There are several exemplary phosphors that can be excited at 250 nm or thereabouts. An exemplary red emitting phosphor is Y.sub.2O.sub.3:Eu.sup.3+. An exemplary yellow emitting phosphor is YAG:Ce.sup.3+. Exemplary green emitting phosphors include CeMgAl.sub.11O.sub.19:Tb.sup.3+, ((lanthanide)PO.sub.4:Ce.sup.3+,Tb.sup.3+) and GdMgB.sub.5O.sub.10:Ce.sup.3+,Tb.sup.3+. Exemplary blue emitting phosphors are BaMgAl.sub.100.sub.17:Eu.sup.2+ and (Sr,Ba,Ca).sub.5(PO.sub.4).sub.3Cl:Eu.sup.2+. For longer wavelength LED excitation in the 400-450 nm wavelength region or thereabouts, exemplary optical inorganic materials include yttrium aluminum garnet (YAG or Y.sub.3Al.sub.5O.sub.12), terbium-containing garnet, yttrium oxide (Y.sub.2O.sub.3), YVO.sub.4, SrGa.sub.2S.sub.4, (Sr,Mg,Ca,Ba)(Ga,Al,In).sub.2S.sub.4, SrS, and nitridosilicate. Exemplary phosphors for LED excitation in the 400-450 nm wavelength region include YAG:Ce.sup.3+, YAG:Ho.sup.3+, YAG:Pr.sup.3+, YAG:Tb.sup.3+, YAG:Cr.sup.3+, YAG:Cr.sup.4+, SrGa.sub.2S.sub.4:Eu.sup.2+, SrGa.sub.2S.sub.4:Ce.sup.3+, SrS:Eu.sup.2+ and nitridosilicates doped with Eu.sup.2+.

Luminescent materials based on ZnO and its alloys with Mg, Cd, Al are preferred. More preferred are doped luminescent materials of ZnO and its alloys with Mg, Cd, Al which contain rare earths, Bi, Li, Zn, as well as other luminescent dopants. Even more preferred is the use of luminescent elements which are also electrically conductive, such a rare earth doped AlZnO, InZnO, GaZnO, InGaZnO, and other transparent conductive oxides of indium, tin, zinc, cadmium, aluminum, and gallium. These transparent conductive oxides, oxynitrides and nitrides are also luminescent as both interconnect means and/or wavelength conversion means. Other phosphor materials not listed here are also within the scope of this invention.

Quantum dot materials are small particles of inorganic semiconductors having particle sizes less than about 30 nanometers. Exemplary quantum dot materials include, but are not limited to, small particles of CdS, CdSe, ZnSe, InAs, GaAs and GaN. Quantum dot materials can absorb light at first wavelength and then emit light at a second wavelength, where the second wavelength is longer than the first wavelength. The wavelength of the emitted light depends on the particle size, the particle surface properties, and the inorganic semiconductor material.

The transparent and optically inert host materials are especially useful to spatially separate quantum dots. Host materials include polymer materials and inorganic materials. The polymer materials include, but are not limited to, acrylates, polystyrene, polycarbonate, fluoroacrylates, chlorofluoroacrylates, perfluoroacrylates, fluorophosphinate polymers, fluorinated polyimides, polytetrafluoroethylene, fluorosilicones, sol-gels, epoxies, thermoplastics, thermosetting plastics and silicones. Fluorinated polymers are especially useful at ultraviolet wavelengths less than 400 nanometers and infrared wavelengths greater than 700 nanometers owing to their low light absorption in those wavelength ranges. Exemplary inorganic materials include, but are not limited to, silicon dioxide, optical glasses and chalcogenide glasses.

The solid-state light source is typically a light emitting diode. Light emitting diodes (LEDs) can be fabricated by epitaxially growing multiple layers of semiconductors on a growth substrate. Inorganic light-emitting diodes can be fabricated from GaN-based semiconductor materials containing gallium nitride (GaN), aluminum nitride (AIN), aluminum gallium nitride (AlGaN), indium nitride (InN), indium gallium nitride (InGaN) and aluminum indium gallium nitride (AlInGaN). Other appropriate materials for LEDs include, for example, aluminum gallium indium phosphide (AlGaInP), gallium arsenide (GaAs), indium gallium arsenide (InGaAs), indium gallium arsenide phosphide (InGaAsP), diamond or zinc oxide (ZnO).

Especially important LEDs for this invention are GaN-based LEDs that emit light in the ultraviolet, blue, cyan and green regions of the optical spectrum. The growth substrate for GaN-based LEDs is typically sapphire (Al.sub.2O.sub.3), silicon carbide (SiC), bulk gallium nitride or bulk aluminum nitride.

A solid state light source can be a blue or ultraviolet emitting LED used in conjunction with one or more wavelength conversion materials such as phosphors or quantum dots that convert at least some of the blue or ultraviolet light to other wavelengths. For example, combining a yellow phosphor with a blue emitting LED can result in a white light source. The yellow phosphor converts a portion of the blue light into yellow light. Another portion of the blue light bypasses the yellow phosphor. The combination of blue and yellow light appears white to the human eye. Alternatively, combining a green phosphor and a red phosphor with a blue LED can also form a white light source. The green phosphor converts a first portion of the blue light into green light. The red phosphor converts a second portion of the blue light into green light. A third portion of the blue light bypasses the green and red phosphors. The combination of blue, green and red light appears white to the human eye. A third way to produce a white light source is to combine blue, green and red phosphors with an ultraviolet LED. The blue, green and red phosphors convert portions of the ultraviolet light into, respectively, blue, green and red light. The combination of the blue, green and red light appears white to the human eye.

A power source (not shown) supplies current through the electrical interconnect means 2 and 4 to the solid state light source 6, which emits light of a first wavelength. Electrical interconnect means 2 and 4 are transmissive to light of the first wavelength emitted by the solid-state light source 6. The first wavelength light will be emitted through the electrical interconnect means 2 and then through the wavelength conversion element 1; or through the electrical interconnect means 4, reflected from the reflective layer 5, through the solid state light source 6, through the electrical interconnect means 2 and then through the wavelength conversion element 1. The wavelength conversion element 1 will convert some of the light of a first wavelength into light of a second wavelength. The second wavelength is different from the first wavelength. The light of the second wavelength will be transmitted out of the wavelength conversion element 1. The remainder of the unconverted light of the first wavelength will also be transmitted out of the wavelength conversion element 1 with the light of the second wavelength. The combination of light of the first wavelength with light of the second wavelength provides a broader emission spectrum of light from the combination of a solid-state light source 6 and a solid wavelength conversion element 1. The combination light is Lambertian and directional from the panel light source.

Electrical interconnect means 2 is positioned between the solid-state light source 6 and the solid wavelength conversion element 1. Alternately, the solid wavelength conversion element 1 may be electrically conductive and able to deliver current to the solid-state light source 6.

The solid-state light source 6 may be a plurality of solid-state light sources. This plurality of solid-state light sources can be arranged co-planar or vertically for the panel light source. A single solid wavelength conversion element 1 or a plurality of solid wavelength conversion elements can be used with the plurality of solid-state light sources.

A barrier layer 3 may be used between and parallel to the plurality of solid state light sources between the electrical interconnect means 2 and 4 to isolate interconnect means 2 and 4. This barrier layer 3 may be used to form environmental and electrically insulative protection for the solid-state light sources 6. The barrier layer includes, but is not limited to, sol-gels, glasses, epoxies and frits.

Spectrum, angular, and polarization means such as dichroic films, microoptics, and reflective polarizers, either on or in proximity to the panel light source, may modify the output distribution of the panel light source of FIG. 1.

FIG. 2 depicts a substantially isotropic panel light source, which consists of a solid-state light source 12 between two solid wavelength conversion elements 8 and 9. The substantially isotropic panel light source has a first solid wavelength conversion element 8, a first electrical interconnect means 10, a solid-state light source 12, a second electrical interconnect means 11, and a second solid wavelength conversion element 9. The first solid wavelength conversion element 8 and the second solid wavelength conversion element 10 are formed of the same wavelength conversion material and both convert light of a first wavelength into light of the same second wavelength. As in the FIG. 1 structure, the light source 12 in FIG. 2 is shown as multiple elements and the total emitting area of these elements is much less than the cross-sectional area of either of the wavelength conversion elements 8 and 9 between which the light source elements 12 are mounted. As such, a main element of this disclosure is a panel light wherein the wavelength conversion element 8 and 9 has a cross sectional area which greater than the light source elements 12 embedded within the wavelength conversion elements 8 and 9. The heat associated with light source elements 12 and wavelength conversion elements 8 and 9 is spread via thermal conduction to the outer surface of wavelength conversion elements 8 and 9 where the heat is conducted to the surrounding ambient. The surrounding ambient may consist of a gas, a liquid, or a solid. Preferably, the surrounding ambient is free air, which allows for natural convection cooling of the outer surface of wavelength conversion element 8 and 9. Even more preferably, the surrounding ambient includes a fixture containing at least one air flow restriction element such that induced draft cooling is possible. As an example, natural convection cooling for small objects can typically transfer 0.5 watts/cm2 of surface area while maintaining a surface temperature of less than 100 C. A 100 lumens panel light operating at 100 lumens/watt dissipates approximately 0.7 watts of heat (0.3 watts exists the source as visible light). If the surface area of the panel light is greater than 1.5 cm2 the panel light can maintain a surface temperature under 100 C using natural convection alone. It is known in the art that induced draft cooling can increase the number of watts per cm2 by a factor of 2×, forced air cooling can increase this by 10×, and liquid cooling can be used to increase the watts/cm2 that can be removed from surface a factor of over 10,000× based on nucleated boiling. As such the proper combination of surface area and heat density for a given ambient condition allows for a wide range of operation using this approach.

A power source (not shown) supplies current through the electrical interconnect means 10 and 11 to the solid state light source 12, which emits light of a first wavelength. Electrical interconnect means 10 and 11 are transmissive to light of the first wavelength emitted by the solid-state light source 12.

The first wavelength light will be emitted from the solid state light source 12 through the electrical interconnect means 10 to the wavelength conversion element 9. The first wavelength light will also be emitted from the solid state light source 12 through the electrical interconnect means 10 to the wavelength conversion element 8. Light 15 and 14 is emitted from both sides of the planar light source of FIG. 2.

The first wavelength light will be emitted from the solid state light source 12 through the electrical interconnect means 11 to the wavelength conversion element 9. The wavelength conversion element 9 will convert some of the light of a first wavelength into light of a second wavelength. The second wavelength is different from the first wavelength. The light of the second wavelength will be transmitted out of the wavelength conversion element 9. The remainder of the unconverted light of the first wavelength will also be transmitted out of the wavelength conversion element 9 with the light of the second wavelength. The combination of light of the first wavelength with light of the second wavelength provides a broader emission spectrum of light 15 from the combination of a solid-state light source 12 and a solid wavelength conversion element 9.

At the same time, the first wavelength light will be emitted from the solid state light source 12 through the electrical interconnect means 10 to the wavelength conversion element 8. The wavelength conversion element 8 will convert some of the light of a first wavelength into light of a second wavelength. The second wavelength is different from the first wavelength. The light of the second wavelength will be transmitted out of the wavelength conversion element 8. The remainder of the unconverted light of the first wavelength will also be transmitted out of the wavelength conversion element 9 with the light of the second wavelength. The combination of light of the first wavelength with light of the second wavelength provides a broader emission spectrum of light 14 from the combination of a solid-state light source 12 and a solid wavelength conversion element 8.

Light is emitted from both sides of the planar light source of FIG. 2. The combination light from both sides of the planar light source is substantially isotropic from the panel light source. If the output from each side is Lambertian, then the light source is an isotropic emitter. If a dichroic, microoptic, polarizer, or photonic crystal structure is added to the luminescent element, the light source will be a directional emitter from one or both sides.

The solid-state light source 12 may be a plurality of solid-state light sources. This plurality of solid-state light sources can be arranged co-planar or vertically for the panel light source. A single solid wavelength conversion element 9 or 8 or a plurality of solid wavelength conversion elements can be used with the plurality of solid-state light sources.

A barrier layer 13 may be used between and parallel to the plurality of solid state light sources between the electrical interconnect means 11 and 10 to isolate interconnect means 11 and 10. This barrier layer 13 may be used to form environmental and electrically insulative protection for the solid-state light sources 12. The barrier layer includes, but is not limited to, sol-gels, glasses, epoxies and frits. Barrier layer 13 may also contain luminescent elements including but not limited to dyes, powders and quantum dots. The desired wavelength conversion of solid-state light source 12 may occur in part or in total within Barrier layer 13. As an example, CeYag ceramics may be used for solid wavelength conversion element 9 and 8 and barrier layer 13 may consist of a silicone organic matrix containing a red oxynitride phosphor powder with a peak wavelength of 650 nm. The phosphor powder may be uniformly or spatially distributed throughout barrier layer 13. Alternately, solid wavelength conversion element 9 and 8 may be translucent alumina ceramic, which is non-luminescent, and the wavelength conversion occurs substantially within the barrier layer 13 which can contain a wide range of luminescent elements. Most preferably, the bulk of the wavelength conversion occurs within solid wavelength conversion elements 9 and 8 such that thermal losses associated with stokes shift and quantum losses are spread over a larger volume of material. This allows for more uniform temperature gradients within the solid-state panel light, which in turn leads to more effective cooling of the source. In all cases, however the emitting surface of the solid-state panel light also serves as the cooling surface for the source, thereby eliminating the need for additional cooling means such as a heat sink.

As in FIG. 1, intrinsically electrically conductive solid wavelength conversion elements 8 and/or 9 of FIG. 2 may be used alternately, or in combination with one or both of interconnect means 10 and/or 11, to deliver power to solid-state lighting source 12. The use of freestanding epitaxial chips, which emit substantially isotropical light, are a preferred solid-state light source.

Spectrum, angular, and polarization means such as dichroic films, microoptics, and reflective polarizers, either on or in proximity to the panel light source, may modify the output distribution of the panel light source of FIG. 2.

FIG. 3 depicts a lighting fixture that reflects and directs the light from a directional panel light source 16 substantially down a vertical surface 17 to form a wall washing effect. The directional panel light 16 is positioned on the vertical surface 17. A curved reflector 18 is spaced from the directional panel light 16 and the vertical surface 17, starting roughly parallel to the directional panel light 16 and curving outward and down from the directional panel light source. The curved reflector will reflect and direct light emitted from the directional panel light source down the vertical surface. The vertical surface 17 can be a mount or a wall. The curved reflector can be supported by the vertical surface.

Airflow 19 is between the vertical surface 17 and the curved reflector 16 past the directional light source 16 and exits through at least one opening in reflector 18. The airflow is via induced draft effects created by the heat generated by the directional light source 16 and the induced draft structure created by vertical surface 17 and curved reflector 16. The airflow cools the directional light source 16. Fixture design creates induced draft cooling channels around or in proximity to the panel light. The thermally conductive luminescent element converts at least a portion of the light emitted from the solid state light source into a broader emission spectrum, but also serves to diffuse/distribute the light generated, as well as provide a cooling path for itself and the solid state light source to the surrounding ambient via convection off the surface of the thermally conductive luminescent element.

Baffling can be optionally used to prevent light leakage through the opening in the curved reflector 18. Also alternately, the directional panel light source 16 can emit a portion of light through the opening in the curved reflector 18 to provide up lighting.

Optionally, thermal conduction and additional cooling means, such as thermoelectric coolers, heat sinks and heat pipes, can be added to directional panel light source 16 to further cool the directional panel light 16.

Alternately, the curved reflector can extend upward to direct the light from the light source in an up direction to form a wall washing effect. Also, alternately, the reflector can be straight or another geometric shape or non-geometric shape. The only requirement is that the reflector be angled away from the directional panel light source on the vertical surface of the wall or mount.

FIG. 4 depicts a light fixture having a substantially isotropic panel light source 20 between two reflectors 21 and 22. A first support member 25 supports and separates the first reflector 22 from the isotropic panel light source 20. A second support member 26 supports and separates the isotropic panel light source 20 from a second reflector 21. The first and second reflectors are curved reflectors, which curve down and outward from the light source. The curves of the first and second reflectors are opposite and mirror images of the other. Reflectors 21 and 22 form a trough reflector for the light emitted by substantially isotropic panel light source 20 to be reflected and directed downward.

Reflectors 21 and 22 also form a cooling means allowing airflow 24 and 23. Airflow 24 is adjacent to the curved first reflector 22 past the isotropic light source 20 and exits past the first support member 25. Airflow 23 is adjacent to the curved second reflector 21 past the isotropic light source 20 and exits past the second support member 26. The airflow 24 and 23 are via induced draft effects created by the heat generated by the directional light fixture 21 and the control of airflow by curved first reflector 22 and curved second reflector 21. As known in the art, induced draft cooling structures can increase the convective cooling coefficient on a heated surface by over an order of magnitude. This approach has typically been used in electronic enclosures such as computer cabinets where a fan is not desired. The proper design of curved first reflector 22 and curved second reflector 21 can allow for enhanced cooling of isotropic light source 20 as well as be used as a reflector of the light generated by isotropic light source 20. The airflow cools the isotropic light source 20 on both sides.

Again, baffling can be optionally used to prevent light leakage through the first and second support members 25 and 26. Also alternately, the isotropic panel light source 20 can emit a portion of light past the first and second support members 25 and 26 to provide up lighting.

FIG. 5 depicts a curved panel light source 27 for a light fixture. Light 28 may be emitted on the concave curve of the panel light source 27 and/or light 29 may be emitted on the convex curve of the panel light source 27. Light 28 and 29 may be emitted from both sides of the panel light source 27. The panel light source 27 may be Lambertian or isotropic. Ceramic and glass based thermally conductive luminescent elements can be easily manufactured in a non-flat shape for curved panel light source 27.

FIG. 6 depicts the use of magnetic elements 36 and 35 to make electrical connection between fixture contacts 33 and 34 and light source contacts 31 and 32 on panel light source 30 for a light fixture. Fixture contacts 33 and 34 are stationary and fixed in position. Light source contacts 31 and 32 and attached panel light source 30 are movable. The panel light source 30 has a small mass and rigid construction. The small mass is a critical element of this invention. Unlike conventional solid-state light sources, no heat sinking or additional heat spreading means are required for the panel light source 27 disclosed in this invention. This allows for the use of realistic magnetic contact methods. Greater than 20 lumens/gram is disclosed and even more preferably greater than 50 lumens per gram is disclosed for panel light source 27. First magnetic element 36 will attract first light source contact 32 until the first light source contact 32 makes physical contact with first fixture contact 34 and stops, remaining in physical contact and electrical connection with first fixture contact 34. Second magnetic element 35 will attract second light source contact 31 until the second light source contact 31 makes physical contact with second fixture contact 33 and stops, remaining in physical contact and electrical connection with second fixture contact 33. The first and second magnetic elements 36 and 35 serve to hold the panel light source in position and hold the light source contacts 32 and 31 to the fixture contacts 34 and 31. Alternately, first and second magnetic elements 36 and 35 may be combined with at least two of light source contacts 32 and 31 or fixture contacts 34 and 31 such that first and second magnetic elements 36 and 35 are part to the electrical path for the fixture.

FIG. 7 depicts a panel light source 31 with an energy storage means 32 and solar cell conversion means 33 for a light fixture. Sunlight or external light will be incident upon the solar cell conversion means 33 which will convert the sunlight or external light into electricity. The solar cell conversion means 33 can be a standard silicon-based solar cell. The electricity will flow from the solar cell conversion means 33 to the adjacent energy storage means 32. The energy storage means 32, such as a battery or capacitor will store the electricity. The electricity will flow from the energy storage means 32 to the adjacent panel light source 31 which will emit light. The rigid nature of the thermally conductive luminescent element within the panel light source 31 provides support and cooling means for both the energy storage means 32 and solar conversion element 33. Using this configuration, a panel light source can be constructed which does not required any external power input other than incident solar energy.

Power conditioning and power converting means enable direct connection to residential and commercial DC, pulsed, or AC power sources directly on the at least one thermally conductive luminescent element. In this case, the at least one thermally conductive luminescent element becomes the substrate to which the electronic components are mounted and cooled. The electronic components may be active and passive electronic devices. Thermal and light sensors can control and protect the large area panel light source. Anti-parallel interconnects between multiple solid-state light sources can be used for direct AC excitation of the panel lights.

Thermally conductive structures within the fixture provide additional cooling to the panel light via attachment to edges or at least some portion of the panel light source. A number of optical designs take advantage of the direct view capability of the at least one panel light source. The size of the panel lights are based on allowable surface brightness, required surface cooling area (which is related to the amount of available airflow and/or conduction cooling), and desired total lumens of output. More preferably, isotropic and directive panel lights have surface areas greater than 1 square inch. Even more preferably, directive and isotropic panel lights with surface brightness of between 1000 and 10000 ftl have surface areas greater than 1 sq inch.

FIG. 8A depicts a self cooling panel light source 40 containing at least one LED die 48 interconnected via electrical traces 46 connected to magnetic contact 42 which mates to contact 44 and electrical trace 47 connected to magnetic contact 41 which mates to contact 45. Contacts 45 and 44 may be magnetic or ferromagnetic. More preferably, contacts 41 and 45 and contacts 42 and 44 are both magnetic but present surfaces toward each other, which are different polarity such that the two contacts attract. Even more preferably, contacts 41 and 42 present surfaces which are opposite polarity to each other such that only one orientation of interconnect is possible based on magnetic attraction of the contacts. As an example contact 41 outer surface exhibits a north polarity while contact 45 exhibits a south polarity towards each other, conversely contact 42 exhibits a south polarity and contact 44 exhibits a north polarity. In this configuration contact 41 and 45 attract and contact 42 and 44 attract but contact 41 and 42 and contact 42 and 45 would repel. In this manner the self-cooling panel light source 40 can only be interconnected in one way preventing application of the voltage to LED die 48 incorrectly.

Connector housing 43 and external electrical interconnect 49 in FIG. 8B may also provide keying and power to the self-cooling panel light source 40. Typically contacts 41, 42, 44, and 45 may consist of rare earth magnets and non-rare earth magnets including but not limited to neodymium, samarium cobalt, alnico, ceramic and ferrite magnets. More preferably contact 41, 42, 44, and 45 are coated with a metal coating including, but not limited to, Cr, Ni, Ag, Au, Cu, rhodium, platinum, palladium, and other electrically conductive materials. Even more preferably contacts are neodymium rare earth magnets coated with NiCuNi with a gold over coat for corrosion resistance. Most preferred is a high temperature neodymium rare earth magnet (operating temperature greater than 150 degrees C. coated with NiCuNi with an overcoat of gold of sufficient thickness to allow attachment of the magnetic contact via low temperature solder such as BiSn. A key attribute of this invention is the light weight of the self-cooling light panel 40, which enables the use of reasonably sized magnetic contacts. Unlike conventional solid-state light sources heat sinks or large surface area metal core boards are not required. This increases the lumens/gram of the source to greater than 20 lumens/gram of source weight. Even more preferably the lumens/gram is greater than 50 lumens/gram. As an example, self-cooling panel light 40 consists of two pieces of ceramic luminescent material with a bulk thermal conductivity greater than 10 W/m/K. Both wavelength conversion and thermal spreading occurs within the ceramic luminescent material such that the emitting surfaces also serve as the cooling surfaces for self-cooling panel light 40. Alternatively, self-cooling panel light 40 may consist of the non-luminescent but translucent thermally conductive materials such as but not limited to translucent polycrystalline alumina, zno, sapphire, mgo, alon, spinel, and other ceramic and single crystal materials, which exhibit a transmission greater than 80% in the visible region. Luminescent conversion of the wavelengths emitted by the solid state LEDs embedded within the self cooling panel light 40 may be via in the introduction of luminescent dyes, powders or elements in the bonding layer used to adhere the self cooling panel light 40 together. In this manner a substantially “white” body color self-cooling panel light 40 may be formed which still allows for the emitting surfaces to be substantially the same as the cooling surfaces.

FIG. 9 depicts a self-cooling solid-state light source consisting of two prismatic wavelength conversion elements 50 and 51 with embedded LED die and interconnect. Coaxial cable is used as the interconnect means having a center conductor 54 and dielectric layer 53 and outer sheath 52. Solid and braided coaxial cables can be the coaxial cable. The cross-sectional view illustrate how the center conductor 54 can be soldered to internal pad 55 and the outer sheath 52 can be soldered to pad 56. The dielectric layer 53 provides isolation of the two electrical connections. Standard coaxial connectors may be further used on the other end of the coaxial cable to interconnect the self-cooling solid-state light source to external power means. Again the self cooling solid state light source consisting of two prismatic wavelength conversion elements 50 and 51 with embedded LED die and interconnect is another example of a surface in which the emitting surface and cooling surfaces are the same. In this case the heat generated by the embedded LED die is thermally conducted to the outer surface of the two prismatic conversion elements 50 and 51. This illustrates the importance of the thermal conductivity on the operation of the self-cooling solid-state light source. As such materials both luminescent and translucent with greater than 10 W/m/K are preferred. The prismatic nature of elements 50 and 51 allows for a different optical path length through the material as compared to the previous rectangular cross-section. This in turn modifies the color temperature of the device by increasing or reducing the amount of light from the embedded LED die, which is converted by the wavelength conversion material. Hemispherical and other cross-sectional shapes can therefore be used to not only change the cooling surface area but also change the color temperature of the self-cooling solid-state light source. In addition, the cross-sectional shape can be used to provide alignment during the manufacturing of the source. As an example, a mating V trough alignment fixture can be used to position the prismatic wavelength conversion elements 50 and 51 such that embedded LED die can be placed without the need for additional visual or computer controlled alignment. This greatly reduces the complexity and cost of manufacturing. Once the embedded LED is attached electrical connections can be made using the coaxial cable. The coaxial cable consists of an outer sheath 52 and an inner conductor 54 separated dielectric barrier 53. The interconnect to source is further illustrated in the side view which references prismatic wavelength conversion element 50 to which referenced outer sheath 52 and inner conductor 54 are electrically attached to contact pads 56 and 55 respectively. The electrical attachment may be via solder, conductive adhesives, or magnetic elements. In particular the use of magnetic ring to connect outer sheath 52 and contact pad 56 is preferred. Standard coaxial connects may be used to further attach the other end of the coaxial cable to a power supply thus providing power to the embedded LEDs in the source. In this manner, a very sleek and visually appealing light source can be generated which can be bent into a wide range of positions.

FIG. 10 depicts multiple magnetically coupled self-cooling solid-state light sources 60, 61, and 62. In this case magnetic contacts 64 and 63 are of opposite polarity to allow for proper interconnect of self-cooling solid-state light sources 60, 61, and 62. External connector 65 and 66 are used to apply current to the string of sources. In this example, external contact 65 would be attracted to contact 67 on source 60, the other side of source 60 would contain contact 68 which attracted to contact 69 on source 61. As stated earlier, contacts 64 and 63 are attracted to each other, and finally contact 70 on source 62 is attracted to external contact 66. In this manner the sources 60, 61 and 62 are connected in series between external contacts 65 and 66. This is just one example of how the sources could be interconnected. But it does illustrate the advantage of the self-cooling light sources versus conventional light sources. Linear and matrix interconnects schemes may also be used. The self cooling light weight nature of self cooling solid state light sources 60, 61, and 62 enables the use of magnetic interconnects such as these. The ability to cool themselves using convection cooling to the surrounding ambient using their emitting surface area enables a wide range of fixture designs. In more conventional LED packages, large heavy external heat sinks are required to cool the devices, which would negate the benefits of magnetic contacts unless very large magnets were used. Magnetically interconnected self-cooling solid-state light sources emitting greater than 30 lumens per gram of light source are a preferred embodiment of this invention. In addition, the self cooling solid state light sources disclosed in this invention exhibit a steady state surface temperature under 80 degrees C. which enables the use of standard neodymium rare earth magnets while still outputting from the self cooling light source greater than 50 lumens for every 1 cm2 of light source areas using natural convective cooling. It should be noted that the surface temperature of the self-cooling solid-state sources is critical both from the L/W performance of the source and from the operation of the magnetic contacts. LED die begin dropping in efficiency at temperatures greater than 80 C and the luminescent materials drop in efficiency as the temperature exceeds 100 C. In addition, rare earth magnets can be demagnetized if the temperature exceeds 100 C for long periods of time. Therefore, self-cooling solid-state light sources which exhibit a surface temperature of less than 100 C is preferred. An even more preferred embodiment of this invention is magnetically coupled natural convective cooled solid state light source emitting more than 50 lumens for every 1 cm2 area of the light source while maintaining a surface temperature less than 80 degrees C. via natural convection cooling is an embodiment of this invention.

FIG. 11 depicts a light fixture containing at least one magnetically couple self cooling light source 90 magnetically coupled via magnetic contacts 91 and 93 to fixture contacts 92 and 94, respectively. Fixture contacts 94 and 92 maybe ferromagnetic or magnetic. Electrical lines 95 and 96 provide power to the self-cooling light source 90 from the canopy 97 attached to a ceiling or wall 98 through the magnetic contacts and the fixture contacts. Alternately, electrical lines 95 and 96 may be magnetic or ferromagnetic wherein magnetic contacts 91 and 93 may be used to directly attach to electrical lines 95 and 96. The use or non-use of polarity keying as discussed above for both are one of the magnetic couplings is and embodiment of this invention.

FIG. 12 depicts a chandelier in which bendable coaxial cables 113 are used to interconnect self cooling solid state light sources 114 to canopy 112 mounted on ceiling 111. This approach allows for a wide range of mounting and even adjustable positioning of the self-cooling solid-state light sources 114.

FIGS. 13A and 13B depict a rotating connector for magnetically coupled self-cooling light sources 80. In this embodiment a center pin 84 mates into a hole in connector housing 81. Magnetic contacts 83 and 82 are drawn to magnetic contacts 85 and 86 respectively. In this manner a more rigid mounting can be created. It is anticipated that other arrangements of keying and mechanical means can be used to stabilize the magnetic contacts disclosed in this invention. The light source with center pin 84 only allows the self cooling light sources 80 to be mated into connector housing 81 a certain distance at which point the magnetic contacts are drawn to each other. Additional keying may be via the spacing of the magnetic contacts from the center pin 84 or via center pin 84 being offset from the centerline of the self-cooling light source 80.

FIG. 14 depicts a self-cooling solid-state light source 73 with embedded spade contacts 70 and 71. Spade contacts consist of metal tabs similar to those used for fuses and other high current devices. The shape and width of the spade contacts can be used for keying as well. Spade contacts typically consist of ½ hard copper or brass coated with tin. Optionally seal material 72 and 74 may be used to electrically isolate the embedded spade contacts 70 and 71 from each other. Using this approach, robust contacts can be integrated into the self-cooling solid-state light source 73 and additional heat can be conducted away from the device via embedded spade contacts 70 and 71 and into an external connector (not shown). The width and thickness of the spade contact allows for the use of standard clip contacts as used in the automotive industry for fuses.

FIG. 15 depicts a prismatic self-cooling solid-state light source 201 with magnetic end contacts 200 and 203. The compact nature of this embodiment allows for efficient operation and also minimizes packaging and shipping costs to the end user. The use of magnetic contacts on each end allows for the formation of strings of sources as disclosed previously in FIG. 10. The resulting light source 201 may be interconnected, packaged and sold in a manner similar to AA batteries. The reduced packaging, shelf space costs and shipping costs are inherent to the design of the light source 201 and are therefore embodiments of this invention. Alternately, contacts 200 and 203 can be thick film metallization that cover the ends of light source 201 and spring clips as typically used to connect batteries may be used instead of magnetic contacts. In this case, some type of orientation indicating a + and − terminal is preferred like batteries to prevent the source 201 from being electrically connect wrong is disclosed. Using this approach self-cooling light source 201 can be sold in individual and multiple packages. The self-cooling light source 201 could be provided in specific lumen output and color temperatures, which could be mixed and matched as the consumer requires. This approach also allows for easy replacement or changing of the light sources as required. A modular approach to solid-state lighting is enabled by self-cooling light sources. Standardized sizes of self-cooling light sources 201 allow for fixtures, which could be upgraded and adapted as technology advances. As an example, self-cooling light source 201 is provided with an output of 100 lumens with a color temperature of 3200K. Ten self-cooling light sources 201 are mounted into a fixture used to light a cubicle. A new employee takes over the cubicle and prefers a color temperature of 2700K with a larger color gamut. The ten self-cooling light sources 201 can be replaced with lower color temperature and larger color gamut sources. It is well known that the long life of solid-state lighting is a major advantage of the technology over incandescent. The disclosed approach, however addresses the need for the light source to adapt to different users and applications without the need for solid-state light sources with active color changing capability. It should be noted that the 3200K light source can be re-used in other applications as long as the source sizes and interconnects are standardized. The absence of a heat sink enables this standardized approach to be possible. Given that solid state light sources may last in excess of 100,000 hours the ability to adjust, color temperature, color gamut, CRI, lumens out, and directionality by simply replacing the sources has not been adequately addressed with conventional solid state light sources.

While the invention has been described with the inclusion of specific embodiments and examples, it is evident to those skilled in the art that many alternatives, modifications and variations will be evident in light of the foregoing descriptions. Accordingly, the invention is intended to embrace all such alternatives, modifications and variations that fall within the spirit and scope of the appended claims.

1. A light fixture comprising
at least one reflector, and
a directional light source having a solid wavelength conversion element on a solid state light source, said solid state light source having a reflecting layer opposite said solid wavelength conversion element such that said solid state light source emits light of a first wavelength through said solid wavelength conversion element or reflected from said reflecting layer through said solid wavelength conversion element, said solid wavelength conversion element converting a portion of said light of a first wavelength into light of a second wavelength, said second wavelength being different from said first wavelength, said light of a first wavelength and said light of a second wavelength being transmitted from said solid wavelength conversion element to form a broader emission spectrum of light from said directional light source to be reflected and directed by said at least one reflector.

2. The light fixture of claim 1 wherein said at least one reflector is separated from said directional light source to provide an induced draft cooling means for said directional light source.

3. The light fixture of claim 1 wherein said broader emission spectrum of light from said directional light source is reflected and directed by said at least one reflector to form a wall washing effect.

4. The light fixture of claim 1 wherein said directional light source is a panel light and said directional light source is standardized.

5. A light fixture comprising
a first reflector and a second reflector, and
an isotropic light source having a first solid wavelength conversion element on a first side of a solid state light source, and a second solid wavelength conversion element on a second side of said solid state light source, said second side being opposite said first side,
wherein said solid state light source emits light of a first wavelength through said first solid wavelength conversion element converting a portion of said light of a first wavelength into light of a second wavelength, said second wavelength being different from said first wavelength, said light of a first wavelength and said light of a second wavelength being transmitted from said first solid wavelength conversion element to form a broader emission spectrum of light from said isotropic light source to be reflected and directed by said first reflector,
wherein said solid state light source emits light of a first wavelength through said second solid wavelength conversion element converting a portion of said light of a first wavelength into light of a second wavelength, said second wavelength being different from said first wavelength, said light of a first wavelength and said light of a second wavelength being transmitted from said second solid wavelength conversion element to form a broader emission spectrum of light from said isotropic light source to be reflected and directed by said second reflector, and
said first reflector and said second reflector forming a trough reflector to reflect and direct said broader emission spectrum of light from said isotropic light source.

6. The light fixture of claim 5 wherein said first reflector is separated from said isotropic light source and said second reflector is separated from said isotropic light source to provide an induced draft cooling means for said isotropic light source.

7. A directional light source for a light fixture comprising
a curved solid wavelength conversion element on a curved solid state light source,
said curved solid state light source having a curved reflecting layer opposite said curved solid wavelength conversion element such that said curved solid state light source emits light of a first wavelength through said curved solid wavelength conversion element or reflected from said curved reflecting layer through said curved solid wavelength conversion element,
said curved solid wavelength conversion element converting a portion of said light of a first wavelength into light of a second wavelength, said second wavelength being different from said first wavelength, said light of a first wavelength and said light of a second wavelength being transmitted from said curved solid wavelength conversion element to form a broader emission spectrum of light from said curved directional light source.

8. An isotropic light source for a light fixture comprising
a first curved solid wavelength conversion element on a first side of a curved solid state light source, and
a second curved solid wavelength conversion element on a second side of said solid state light source, said second side being opposite said first side,
wherein said curved solid state light source emits light of a first wavelength through said first curved solid wavelength conversion element converting a portion of said light of a first wavelength into light of a second wavelength, said second wavelength being different from said first wavelength, said light of a first wavelength and said light of a second wavelength being transmitted from said first curved solid wavelength conversion element to form a broader emission spectrum of light from said isotropic light source, and
wherein said curved solid state light source emits light of a first wavelength through said second curved solid wavelength conversion element converting a portion of said light of a first wavelength into light of a second wavelength, said second wavelength being different from said first wavelength, said light of a first wavelength and said light of a second wavelength being transmitted from said second curved solid wavelength conversion element to form a broader emission spectrum of light from said isotropic light source.

9. A light fixture comprising
a light source having a first contact and a second contact,
a fixture having a first fixture contact and a second fixture contact, and
a first magnetic element and a second magnetic element,
wherein said first magnetic element magnetically attracts said first contact of said light source to physically contact and electrically connect said first fixture contact and wherein said second magnetic element magnetically attracts said second contact of said light source to physically contact and electrically connect said second fixture contact.

10. The light fixture of claim 9 wherein said light source is separated from said fixture to provide an induced draft cooling means for said light source.

11. The light fixture of claim 10, further comprising said fixture being a canopy, and
bendable coaxial cables, said source mechanically and electrically connected to said canopy via said bendable coaxial cables.

12. The light fixture of claim 10 wherein said first fixture contact, said second fixture contact, said first magnetic element and said second magnetic element are magnetically polarity keyed.

13. A light source for a light fixture comprising
a solar cell conversion means for converting sunlight or external light into electricity,
an energy storage means, said solar conversion means being on said energy storage means, said energy storage means for storing said electricity from said solar cell conversion means, and
a panel light source, said energy storage means being on said panel light source, said panel light source receiving electricity from said energy storage means and emitting light.

14. The light source for a light fixture of claim 13 wherein said panel light source has at least one solid wavelength conversion element on a solid state light source, such that said solid state light source emits light of a first wavelength through said at least one solid wavelength conversion element, said at least one solid wavelength conversion element converting a portion of said light of a first wavelength into light of a second wavelength, said second wavelength being different from said first wavelength, said light of a first wavelength and said light of a second wavelength being transmitted from said at least one solid wavelength conversion element to form a broader emission spectrum of light from said panel light source.

15. A self-cooling solid-state light source comprising
at least one light emitting die connected to a first magnetic contact and a second magnetic contact;
a third magnetic contact with a different magnetic polarity than said first magnetic contact; and
a fourth magnetic contact with a different magnetic polarity than said second magnetic contact;
wherein said first magnetic contact magnetically attracts said third magnetic contact to physically contact and electrically connect said first magnetic contact to said third magnetic contact and wherein second magnetic contact magnetically attracts said fourth magnetic contact to physically contact and electrically connect said second magnetic contact to said fourth magnetic contact.

16. The self-cooling solid-state light source of claim 15 wherein said at least one light emitting die emits greater than 20 lumens per gram.

17. The self-cooling solid-state light source of claim 15 wherein said at least one light emitting die emits greater than 50 lumens per square centimeter and wherein said at least one light emitting die is naturally convectively cooled to a surface temperature less than 80 degrees C.

18. The self-cooling solid-state light source of claim 15 further comprising multiple light emitting die, each die connected to a different first magnetic contact and a different second magnetic contact;
a different third magnetic contact with a different magnetic polarity than said different first magnetic contact; and
a different fourth magnetic contact with a different magnetic polarity than said different second magnetic contact;
wherein said different first magnetic contact magnetically attracts said different third magnetic contact to physically contact and electrically connect said different first magnetic contact to said different third magnetic contact and wherein different second magnetic contact magnetically attracts said different fourth magnetic contact to physically contact and electrically connect said different second magnetic contact to said different fourth magnetic contact.
